(19) United States
(12) Patent Application Publication
(10) Pub. No.: US 2007/0139003 A1
(43) Pub. Date: Jun. 21, 2007

(54) Wearable battery complements wearable terminal at cold temperatures

(76) Inventor: Chris Paul, Bayport, NY (US)

Correspondence Address: FAY KAPLUN & MARCIN, LLP, 15O BROADWAY, SUITE 702, NEW YORK, NY, 10038, US

(21) Appl. No.: 11/305,562

(22) Filed: Dec. 16, 2005

(51) Int. Cl. H02J 7/00

(52) U.S. Cl. 320/114

(57) ABSTRACT

Described is a system and, in particular, to a wearable battery system for a terminal. The system may include a battery and a harness holding the battery in proximity to a body of a wearer of the harness. The battery and harness are worn underneath an outer garment thereby preventing a temperature of the battery from reaching an ambient temperature of an environment in which the wearer is located.

### BACKGROUND

Batteries allow electronic devices to be used portably without a grounded source of energy. Batteries are particularly useful when no energy source is available and only a stored energy pack (i.e., battery) is available. However, when using batteries, temperature plays a big role in the performance of the battery which in turn affects the performance of the device that is using the battery for energy. When temperatures start to drop, the battery performance also drops as the chemical reactions that occur inside the battery are slowed down. When temperatures drop below a certain level, the performance of the battery stops. Thus, there is a need to keep batteries as warm as possible when the device is used in low temperature environments.

### SUMMARY OF THE INVENTION

The present relates to a system and, in particular, to a wearable battery system for a terminal. The system may include a battery and a harness holding the battery in proximity to a body of a wearer of the harness. The battery and harness are worn underneath an outer garment thereby preventing a temperature of the battery from reaching an ambient temperature of an environment in which the wearer is located.

### DESCRIPTION OF THE DRAWINGS

FIG. 1 illustrates an exemplary embodiment of a battery that completes a circuit with a load.

FIG. 2 illustrates a graphical representation of an effect of temperature on battery performance.

FIG. 3 illustrates an exemplary embodiment of a battery maintaining a higher temperature using body heat according to the present invention.

FIG. 4 illustrates a second exemplary embodiment of a battery maintaining a higher temperature using body heat according to the present invention.

### DETAILED DESCRIPTION

The present invention may be further understood with reference to the following description and the appended drawings, wherein like elements are referred to with the same reference numerals. The exemplary embodiment of the present invention describes a method for wearing a battery that complements a wearable terminal at cold temperatures. The wearing of the battery and the method of complementing a wearable terminal will be discussed in detail below.

In the exemplary embodiments, the exemplary battery is described as a lithium ion battery. However, those of skill in the art will understand that the use of the lithium ion battery is only exemplary and that the present invention may be applied to any type of battery. Other examples of batteries include zinc-carbon batteries, alkaline batteries, lithium batteries, and nickel metal hydride batteries. All these battery types exhibit a system that utilizes the transfer of negative charges to create or store energy.

It should be noted that the term “battery” will be used to encompass both a battery and a cell. A cell is a single unit, potentially one cell in a battery of multiple cells or possibly the entire device. A battery is a device for creating or storing electrical energy composed of several similar cells that are connected together. However, common usage of the term “battery” encompasses both a cell and a battery and the following description will use the term “battery” interchangeably to mean both a cell and a battery.

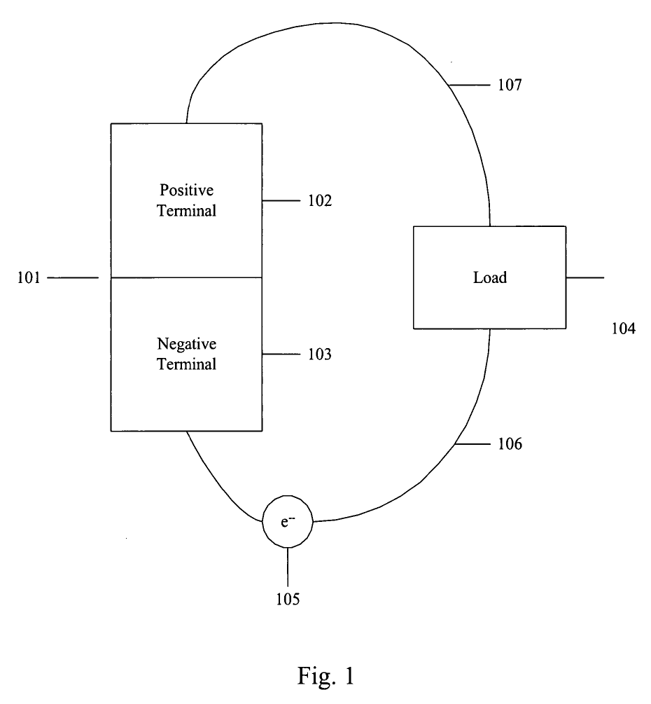

FIG. 1 illustrates how a basic battery functions when it is used to power a load by discharging energy. The battery 101 is composed of a positive terminal 102 (i.e., cathode) and a negative terminal 103 (i.e., anode). Within the battery is also an electrolyte that is used to act chemically on the terminals. The cathode 102 is an electrode at which the electrons go into a battery. The anode 103 is an electrode at which the electrons flow out of the battery to the circuit. The exemplary embodiments exhibit a system where the flow of electrons will occur from anode 103 to cathode 102.

When wire 106 (or other connecting device) is connected to the anode 103, electrons 105 will flow from the anode 103 through the wire 106. The wire 106 is a conductor that allows for a free flow of electrons 105 through it (e.g., copper, silver, platinum). In order to utilize the result of the flow of electrons (i.e., creation of energy), a load 104 is placed in between the circuit created between the anode 103 and the cathode 102. The load 104 is a device that uses energy to function. In the exemplary embodiments of the present invention, the load 104 is a mobile computing device that may include power drawing components such as, a display screen, a processor, a radio, a speaker, etc. However, those of skill in the art will understand that the load 104 may be any device that will be used in a low temperature environment. When the load 104 is connected to the anode 103 of the battery 101 via the wire 106, the circuit is completed by using a wire 107 to connect the load 104 to the cathode 102.

When the circuit is completed, inside the battery 101, the electrons 105 collect on the anode 103 by a chemical reaction that produces the electrons 105. The speed of electron production by this chemical reaction (i.e., the battery's internal resistance) controls how many electrons may flow between the terminals. This electron production is dependent on what chemicals are used within the battery (e.g., zinc cathode and carbon anode). Once a circuit is completed, the electrons 105 will be able to flow from the anode 103 to the cathode 102 to create the energy to be supplied to the load 104. It should be noted that a switch may also be included in the exemplary embodiment. Any circuit with a battery and a load may contain a switch that will either close the circuit or keep the circuit open.

Those of skill in the art will readily understand the inherent problem that arises when the battery 101 is exposed to cold temperatures. The chemical reaction inside the battery 101 that produces the electrons 105 and the flow of the electrons 105 through the wires 106 and 107 are significantly slowed down so that very little energy may be drawn to run the loads 104. Consequently, run times will suffer and any load 104 that is connected to the battery will function for a much shorter period of time, if at all, than if the battery is functioning at an optimal temperature with optimal flow of electrons 105.

Temperature affects the performance of a battery on both extremes. When the temperature is too high, unwanted or irreversible chemical reactions and/or loss of electrolytes may occur that may cause permanent damage or complete failure of the battery. When the temperature is too low, the chemical reactions may be severely slowed down and/or the electrolytes may freeze that may also cause permanent damage or complete failure of the battery. Ordinarily, a proper temperature is sought that will optimize the performance of the battery, but the present invention pertains to when the battery is exposed to the lower extreme of cold temperatures.

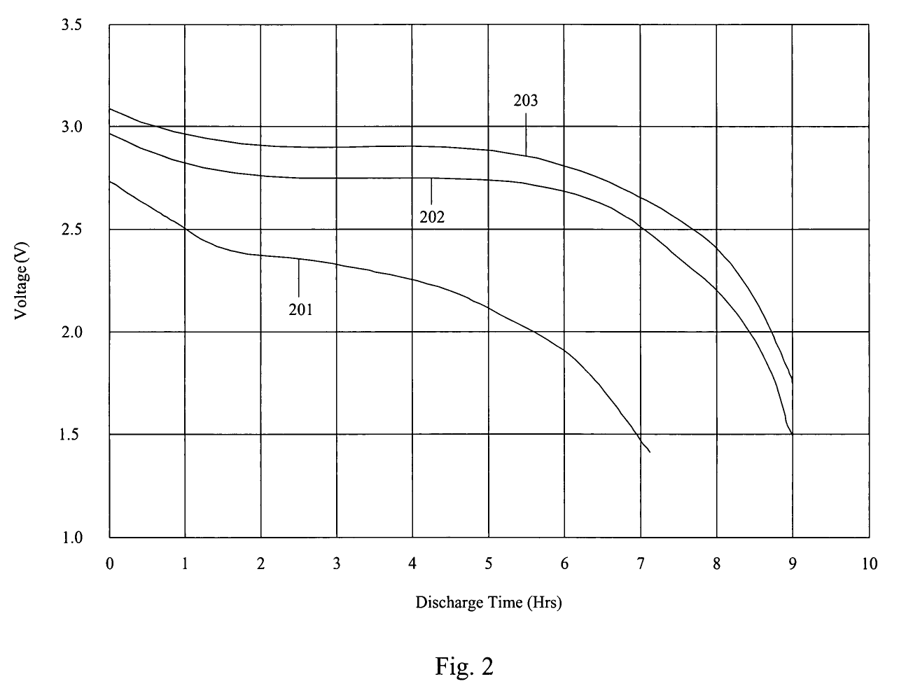

FIG. 2 shows a graphical representation of the effect of temperature on the performance of a lithium ion battery. FIG. 2 shows a graph of voltage versus discharge time in hours. The curve 203 represents a battery performance at 55° C. At a discharge time of 0 hours, the voltage is approximately 3.05V. At a discharge time of 9 hours, the voltage is approximately 1.75V. The voltage performance of the battery at 55° C. is relatively stable for times 0-8 hours. The curve 202 represents a battery performance at 20° C. At a discharge time of 0 hours, the voltage is approximately 2.95V. At a discharge time of 9 hours, the voltage is approximately 1.45V. While the battery's performance is slightly worse at 20° C. compared to 55° C., the performance remains relatively stable for times 0-8 hours. The curve 201 represents a battery performance at −20° C. At a discharge time of 0 hours, the voltage is approximately 2.75V. At a discharge time of 7 hours, the voltage is approximately 1.40V. However, as shown by the curve 201, the battery's performance is significantly degraded compared to the performance at higher temperatures. It should be noted that battery performance may be even further degraded at −20° C. outside a controlled laboratory environment (e.g., 40% or less of original performance).

Through comparison of curves 203, 202, and 201, generally, it is apparent that as temperature increases, the performance of the battery increases as well. As temperatures reach much higher values (e.g., greater than 55° C.), the performance peaks and results in diminishing returns. However, again, this invention pertains to the range of temperatures where an increase in temperature results in an increase in battery performance.

The Arrhenius Law gives a relationship between the rate of a chemical reaction and temperature. The Arrhenius Law states that k=Ae^{-E/RT}, where k is a rate constant, A is a frequency factor specific to a reaction, E is an activation energy specific to a reaction, R is a molar rate constant, and T is a temperature. The Arrhenius Law states that the rate, k, at which a chemical reaction proceeds increases exponentially with temperature, T. This results in more instantaneous power to be extracted from the battery at higher temperatures. At the same time, higher temperatures improve electron mobility, reducing the battery's impedance and increasing its capacity. Thus, it is noticeable that even a slight increase in temperature will result in an increased rate of the chemical reaction occurring inside a battery that in turn increases the performance of the battery itself.

The present invention takes advantage of the fact that in cold temperatures, a person will wear clothing, usually coats or heavy jackets, that trap heat. This allows the body to maintain a comfortable body temperature. The average temperature of a body is within the range of temperature where a battery will function normally without any retardation in performance due to cold.

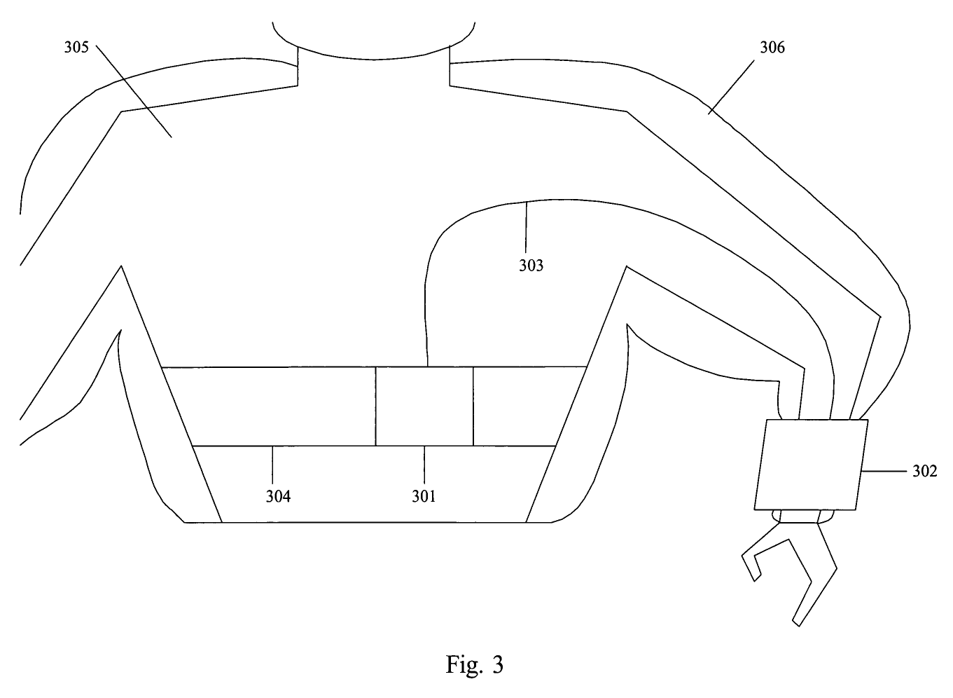

FIG. 3 illustrates an exemplary embodiment of how the present invention may be utilized in cold temperatures. A battery 301 is secured against a body 305 using a harness 304. The harness 304, the battery 301 and the body 305 are all underneath an outer clothing 306 (e.g., over garments or other clothes, but beneath a jacket or other type of outerwear). In cold exterior temperatures, the outer clothing 306 is used to trap body heat within the outer clothing 306 to keep the body 305 in a comfortable temperature range (e.g., above 0° C. (i.e., freezing temperature), below 37° C. (i.e., normal body temperature)).

The human body 305 maintains a relatively constant body temperature despite a different exterior temperature. Due to humans being warm-blooded and through the act of homeostasis, the body temperature does not adjust itself to mimic its surroundings but adjusts itself to maintain a constant body temperature. The human body maintains a body temperature of 37° C. even if the temperature outside the body is well above or below 37° C.

The outer clothing 306 assists in maintaining the constant body temperature. In addition, the outer clothing 306 completely insulates the battery 301 from any exposure to the colder exterior temperature. The outer clothing 306 may be made of many different types of materials so long as it is able to trap heat or prevent heat loss from the outside. It should be noted that the outer clothing 306 is optional if the body 305 is able to maintain a temperature above the temperature of the outside. However, the outer clothing 306 provides a complete surrounding of the battery 301 to better ensure that the battery 301 is maintained at a proper temperature, rather than just the side of the battery that is against the body 305.

The harness 304 that holds the battery 301 is strapped around the torso of the body 305. However, the harness 304 may also be placed on other areas of the body 305 such as the arm and shoulders. For example, the harness 304 may be placed around the upper arm by the biceps or the harness 304 may be a holster worn around the shoulders with a pouch that holds the battery 301. The harness 304 may be strapped against any part of the body through several means. For example, the harness 304 may be an elastic band that circumnavigates the area of the body that it is strapped to or it may contain fasteners such as a buckles, snaps, or hook and loop fasteners.

Attached to the battery 301 are wires 303 that connect to a terminating connector so that the load 302 may be electrically connected to the battery 301. The load 302 will normally be a device that may receive power from a remote battery (e.g., battery 301 harnessed on the body) or a local battery (e.g., a battery mounted directly in or on the load 302). Thus, the terminating connector for the remote battery 301 should be mechanically and electrically compatible with the connector used to connect the local battery to the load 302. Moreover, this will allow both batteries to use the same charging device. In one exemplary embodiment, the terminating connector may take the same form as the local battery, thereby fitting into the same area/space in the load 302 as the local battery, but providing power from the remote battery 301. Those of skill in the art will understand that the connector is not required to have the same form as the local battery, but it should be mechanically and electrically compatible. In addition, as mentioned above, the circuit may contain a switch that allows the user to opt when to close the circuit in order to make the load function. The wires 303 may be surrounded by an insulating material such as rubber in order to prevent any short circuiting and to assure that any current that flows through the circuit will reach its destination. It should be noted that the exemplary embodiments of a battery harness separate from a load and being connected via wires is only exemplary. Other schema that maintain the battery at a higher than ambient temperature exist as will be discussed below.

The load 302 is shown as a wearable terminal attached to a wrist on an arm of the body 305 outside the outer clothing 306. Unlike the battery 301, the load 302 may be placed outside the outer clothing 306, since the temperature of the load 302 has little to no effect on the performance of the battery 301. In addition, the load 302 may be any device that is within a reasonable distance from the body 305 where the battery 301 is harnessed (i.e., within a reasonable length of wires 303). For example, the load 302 may be any handheld electronic device or any electronic device that is capable of being run by a battery that may be harnessed against the body such as a communication device. It should be noted that the load 302 may be placed underneath the outer clothing 306 depending on a user's preference. It should also be noted that the battery 301 may contain other circuitry (e.g., thermistor, integrated circuits, etc.) that may also be electrically connected to parts of the load 302 via a separate set of wires, different from the terminating connector. However, the separate wires would travel in the same bundle as those carrying power from the battery 301 to the load 302.

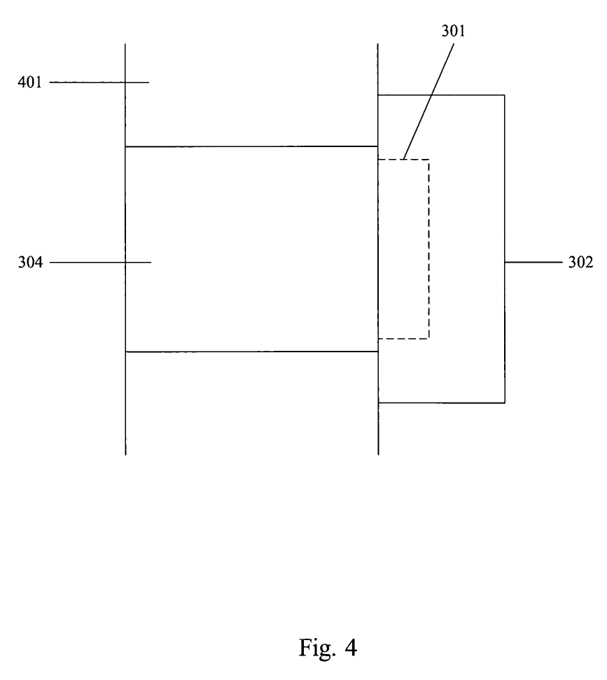

FIG. 4 illustrates a second exemplary embodiment of how the present invention may be utilized in less extreme, cold temperatures. The second exemplary embodiment places a battery 301 within the load 302, thus eliminating a need for exterior wires. Such an embodiment may be preferred when the ambient temperature does not reach extremely cold temperatures. The load 302 is placed on a wrist 401 via a harness 304. This allows the device to be used with less of an encumbrance as there are no exterior wires.

In the second exemplary embodiment, the battery 301 is placed within the load 302 to provide energy from the battery 301 to the load 302. The battery 301 is placed towards the wrist so that heat may be provided by body heat from the wrist 401. It should be noted that the second exemplary embodiment does not require outer clothing the way the first exemplary embodiment illustrates. This is because the battery 301 is placed towards the wrist 401. In addition, the second exemplary embodiment is for cases where the ambient temperature is not as extreme as would be the case for the first exemplary embodiment.

Thus, both the exemplary embodiments of the present invention provide for the battery 301 to be maintained at a constant temperature that is relatively higher than the ambient temperature of the environment in which the device (load) is operating. This allows for better battery performance and less degradation due to low battery temperature.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

1. A system, comprising:
a battery; and
a harness holding the battery in proximity to a body of a wearer of the harness, the battery and harness being worn underneath an outer garment thereby preventing a temperature of the battery from decreasing towards an ambient temperature of an environment in which the wearer is located.

2. The system of claim 1, wherein the battery is one of an individual cell and a multi-cell battery.

3. The system of claim 1, further comprising:
a terminating connector for connecting the battery to a load.

4. The system of claim 3, wherein the load is a mobile computing device.

5. The system of claim 3, wherein the connector includes electrical conducting wires and the load is within a length of the battery to prevent a substantial performance degradation of the battery through the load.

6. The system of claim 3, wherein the connector includes a terminating connector that electrically connects the load to the battery.

7. The system of claim 6, wherein the terminating connector is electronically compatible with a local battery that operates the load.

8. The system of claim 6, wherein the terminating connector is mechanically compatible with a location of the load for connecting a local battery.

9. The system of claim 1, wherein the harness is placed on an area of the body that is one of a torso, an upper arm, a shoulder, and a wrist.

10. The system of claim 1, wherein the harness includes one of a buckle, a snap, and hook and loop fasteners.

11. The system of claim 1, wherein the outer garment is a heat insulating material worn outside the body.

12. The system of claim 1, wherein the ambient temperature is less than 18° C.

13. The system of claim 1, wherein the ambient temperature is less than 0° C.

14. The system of claim 1, wherein the ambient temperature is less than −10° C.

15. The system of claim 1, wherein the temperature of the battery is maintained through a conducting of heat directly or indirectly from the body to the battery.

16. The system of claim 1, wherein the outer garment prevents any exposure of the battery to the environment.

17. (canceled)

18. A system, comprising:
a battery; and
a means for holding the battery in proximity to a body of a wearer, when the body provides heat to the battery preventing the battery from decreasing towards an ambient temperature of an environment in which the body is located.

19. The system of claim 18, further comprising:
a connecting means for connecting the battery to a load.

20. The system of claim 19, wherein the load is a mobile computing device.
